(19) United States
(12) Patent Application Publication
(10) Pub. No.: US 2019/0067979 A1
(43) Pub. Date: Feb. 28, 2019

(54) WIRELESS CHARGING DEVICE AND SYSTEM

(71) Applicant: WIWAVES, INC., Sandy, UT (US)

(72) Inventor: Halston D. van der Sluys, Sandy, UT (US)

(21) Appl. No.: 15/923,987

(22) Filed: Mar. 16, 2018

Related U.S. Application Data
(60) Provisional application No. 62/551,056, filed on Aug. 28, 2017.

(51) Int. Cl. H02J 7/02; H02J 50/10; A41D 1/00; A41D 27/20

(52) U.S. Cl. CPC H02J 7/025; H02J 50/10; A41D 3/00; A41D 27/205; A41D 1/005

(57) ABSTRACT

A wireless charging system includes a wireless charging device comprising a controller, a microstrip coil, and a board. The controller is configured to be coupled to one or more power sources and facilitate transferring power from a power source to a microstrip coil. The microstrip coil is coupled to the controller, and is configured both to receive power from the power source via the controller and create an electromagnetic field for transmitting power to an electronic device. The board is coupled to the controller and the microstrip coil, wherein the wireless charging device is configured to provide power to the electronic device in a particular direction without a ferrite board. The wireless charging system also includes an electronic device that comprises a receiver coupled to a battery. The receiver is configured to receive power from the wireless charging device and provide the received power to the battery.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. As the world becomes more connected, there is a need to power a multitude of mobile devices used for both business and personal use. Such mobile devices include, for instance, smartphones, tablets, notebook computers, smartwatches, dedicated music players, and a variety of other mobile devices, that need to be charged. Each device typically includes a dedicated charger, potentially having a proprietary connection mechanism, that needs to be carried and/or stored.

At least partially based on these issues, wireless chargers that are capable of charging a battery of a device that is merely proximate to the wireless charger have been developed. However, several technical limitations have slowed the wide-spread use and adoption of these wireless chargers, especially in relation to utilization of wireless chargers on-the-go. Such technical limitations include manufactured wireless chargers that are inflexible and bulky. In addition, placement of an electronic device with respect to a wireless charger must often be nearly perfect in order to effectively charge the electronic device. As such, there are several problems in the art to be addressed.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a wireless charging device and a wireless charging system. For example, embodiments may include a controller that is configured to be coupled to one or more power sources. The controller may further be configured to facilitate transferring power from the one or more power sources to a microstrip coil. Embodiments may further include the microstrip coil being coupled to the controller. The microstrip coil may be configured to receive power from one or more power sources via the controller and create an electromagnetic field for transmitting power to an electronic device. Embodiments may further include a board coupled to the controller and the microstrip coil.

In this way, a wireless charging device may be extremely thin, flexible, and light. Such properties (i.e., thickness, flexibility, and weight) may allow the wireless charging device to be integrated within an item of clothing of an individual, as the wireless charging device is configured to flex and bend in response to movements of the individual that is wearing the item of clothing. Notably, these properties are realized based at least partially on the usage of a microstrip coil that does not include strands of coil that touch between different layers of coil. For instance, the microstrip coil, as described herein, allows for controlling magnetic flux of the coil and generating power in a particular direction without the use of a ferrite board. Additionally, these features allow for charging an electronic device to be wireless charged even when placing the electronic device on a single strand of the microstrip coil.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates a wireless charging environment for wirelessly charging an electronic device.

FIG. 2 illustrates a wireless charging environment that includes a tightly pressed coil and a ferrite board.

FIG. 3 illustrates a wireless charging environment that includes a wireless charging device that utilizes a microstrip coil.

FIGS. 4A-4C illustrates various positioning of an electronic device with respect to a wireless charging device for effective wireless charging.

FIGS. 5A and 5B illustrates one item of clothing incorporating a system according to one embodiment of the present disclosure.

FIG. 6 illustrates another item of clothing incorporating a system according to one embodiment of the present disclosure.

FIG. 7 illustrates another item of clothing incorporating a system according to one embodiment of the present disclosure.

FIG. 8 illustrates an item of clothing incorporating a system according to one embodiment of the present disclosure.

FIG. 9 illustrates a wireless charger according to one embodiment of the present invention.

FIG. 10 illustrates a wireless charging device having two microstrip coils.

FIG. 11 illustrates example dimensions of a wireless charging device.

### DETAILED DESCRIPTION

One or more specific embodiments of the present disclosure will be described below. In an effort to provide a concise description of these embodiments, some features of an actual embodiment may be described in the specification. It should be appreciated that in the development of any such actual embodiment, as in any engineering or design project, numerous embodiment-specific decisions will be made to achieve the developers' specific goals, such as compliance with system-related and business-related constraints, which may vary from one embodiment to another. It should further be appreciated that such a development effort might be complex and time consuming, but would nevertheless be a routine undertaking of design, fabrication, and manufacture for those of ordinary skill having the benefit of this disclosure.

At least some embodiments described herein relate to a wireless charging device and a wireless charging system. For example, embodiments may include a controller that is configured to be coupled to one or more power sources. The controller may further be configured to facilitate transferring power from the one or more power sources to a microstrip coil. Embodiments may further include the microstrip coil being coupled to the controller. The microstrip coil may be configured to receive power from one or more power sources via the controller and create an electromagnetic field for transmitting power to an electronic device. Embodiments may further include a board coupled to the controller and the microstrip coil.

In this way, a wireless charging device may be extremely thin, flexible, and light. Such properties (i.e., thickness, flexibility, and weight) may allow the wireless charging device to be integrated within an item of clothing of an individual, as the wireless charging device is configured to flex and bend in response to movements of the individual that is wearing the item of clothing. Notably, these properties are realized based at least partially on the usage of a microstrip coil that does not include strands of coil that touch between different layers of coil. For instance, the microstrip coil, as described herein, allows for controlling magnetic flux of the coil and generating power in a particular direction without the use of a ferrite board. Additionally, these features allow for charging an electronic device to be wireless charged even when placing the electronic device on a single strand of the microstrip coil.

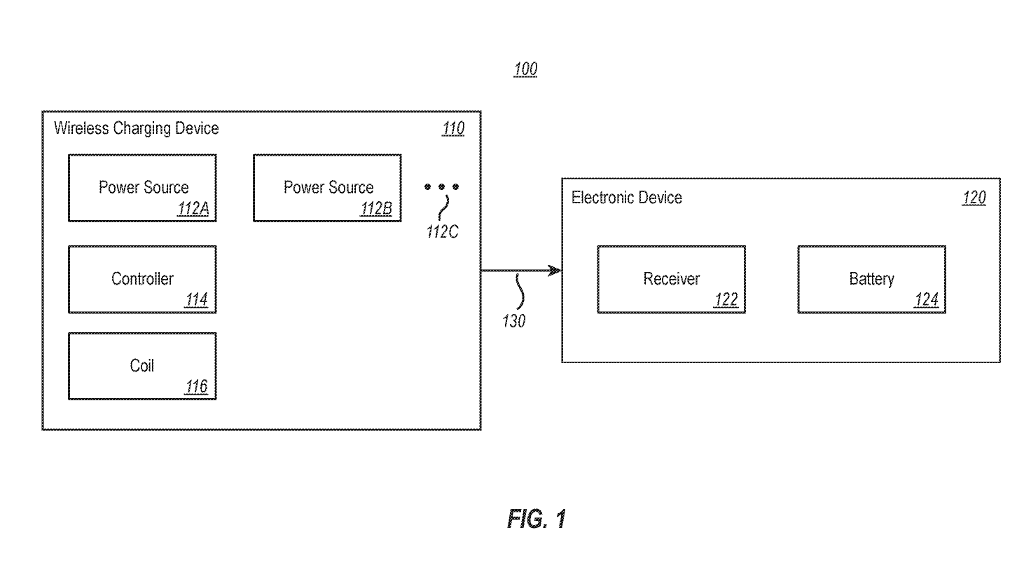

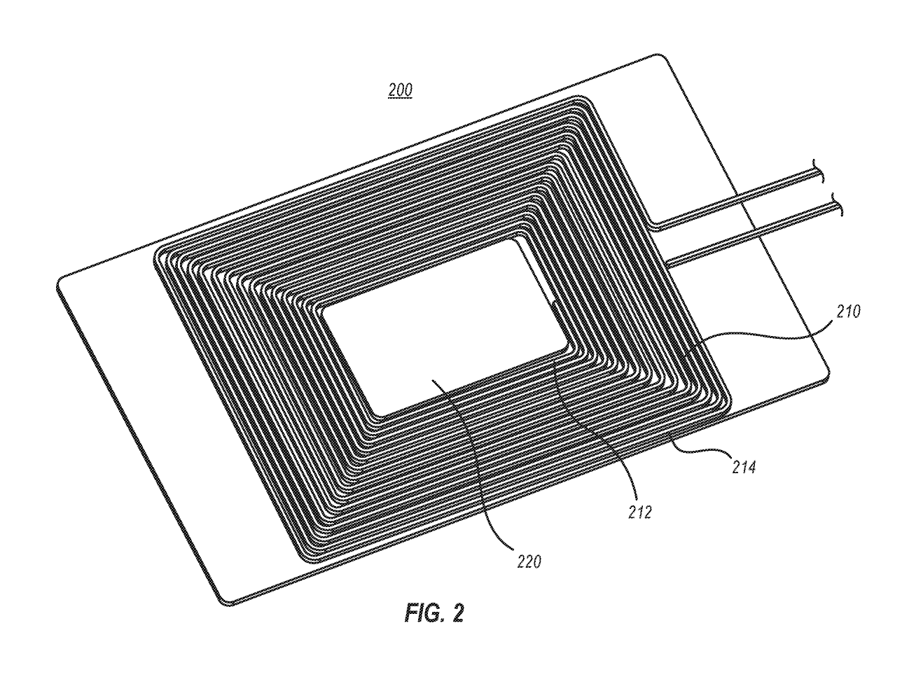

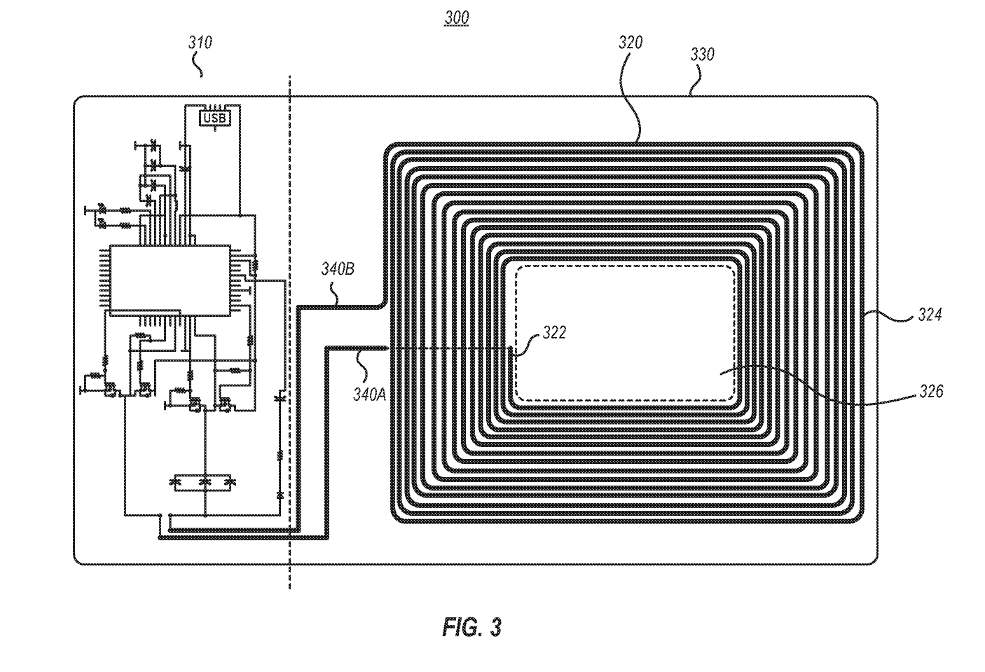

Some introductory discussion of wireless inductive charging will be described with respect to FIGS. 1 and 2. Then a flexible, thin wireless charging device that includes a microstrip coil will be described with respect to FIGS. 3-9.

FIG. 1 illustrates an environment 100 for wireless charging of an electronic device 120 by wireless charging device 110. As illustrated, the wireless charging device 110 may include power sources 112 (i.e., power source 112A and power source 112B), the controller 114, and the coil 116. The power source 112 may include any type of applicable power source, including batteries (e.g., a 5V 3,000 mAH battery), an AC adapter plugged into a wall outlet, and so forth. Notably, while two power sources 112 are shown, ellipses 112C represents that any number of power sources may be used to practice the principles described herein. Additionally, one or more power sources 112 may comprise a different types of power source (e.g., the power source 112A comprises a battery, while the power source 112B comprises an AC adapter) The controller 114 may comprise any applicable type of hardware and/or software that is capable of communicating with both the power sources 112 and the coil 116. In particular, the controller may facilitate transferring power from at least one of the power sources 112 to the coil 116, thus allowing the coil 116 to create an alternating electromagnetic field.

As briefly discussed, the wireless charging environment 100 includes the electronic device 120. In an example, the electronic device 120 may comprise a mobile phone, a tablet, a laptop computer, a smartwatch, a rechargeable battery device, and so forth. Regardless of the type of device, the electronic device 110 may include a receiver 122 and a battery 124. The receiver 122 may comprise any applicable receiver utilized within electronic devices for wireless charging purposes. In an example, the receiver 122 may comprise a receiver. Notably, the receiver 122 may also include a coil. While shown as being a part of, or being included within, the electronic device 120, the receiver 122 may be a separate device. For instance, the receiver 122 may be configured to connect to the electronic device 120 through a communication port (e.g., a micro UNIVERSAL SERIAL BUS (USB™) port). In this way, a device that does not natively include functionality associated with a particular wireless charging standard (e.g., QI), may gain such functionality.

When properly placed in close proximity (e.g., on top of) to the wireless charging device 110, the receiver 122 may receive power (as illustrated by arrow 130) from the alternating electromagnetic field created by the coil 116 of the wireless charging device through inductive coupling. The power received at the receiver 122 may then be converted into electric current, thus resulting in charging of the battery 124. Accordingly, the electronic device 110 may include any necessary hardware or software that allows for converting the power received at the receiver 122 into electric current for charging the battery 124. Notably, the battery 124 may be any type of battery applicable to a device type (e.g., a smart phone, tablet, and so forth) of the electronic device 120.

Previously, such wireless chargers (e.g., wireless charging device 110) have comprised rigid structures that include one or more coils (e.g., single coil wireless chargers, three coil wireless chargers, and so forth) with very little flexibility attached to a rigid ferrite board. Additionally, previous coils have generally been tightly pressed together. For instance, FIG. 2 illustrates a wireless charging environment 200 that includes a tightly pressed coil 210, as well as a ferrite board 220. As shown, starting from the innermost portion 212 of the coil and the outermost portion 214 of the coil, each given coil portion is pressed against (i.e., touching) at least one other coil portion that is located inside and/or outside of the given the coil portion. Notably, when coil portions touch, as illustrated in FIG. 2, energy is held all around the coils and slowly spreads throughout the coil. Often, regardless of the number of coils (e.g., a single coil, three coils, and so forth) a wireless charging device (e.g., the wireless charging device 110) includes, this results in a requirement that placement of an electronic device to be charged (e.g., the electronic device 120) must be relatively accurate with respect to the coil(s) of the wireless charging device. More specifically, the electronic device to be charged, generally, has to be placed directly in the center of a given coil of the wireless charging device in order to properly charge the electronic device's battery.

FIGS. 3 illustrates a wireless charging device 300 that improves upon previous wireless chargers and their corresponding issues, as previously described herein. As shown, the wireless charging device 300 includes a board 330 comprising a circuit portion 310 (i.e., a controller portion, such as controller 114 of FIG. 1) that is connected to a coil 320 via connections 340 (i.e., connection 340A and connection 340B). While reference is made to one coil, it would be understood and contemplated by one skilled in the art, based upon the teaching of the presently described invention, that wireless charging device 300 could have more than one coil (e.g., two coils, three coils, and so forth). Although not shown, wireless charging device has access to a power source (e.g., power source 112A) from which the wireless charging device can withdraw power in order wirelessly charge an electronic device (e.g., the electronic device 120), as further described herein. For instance, such power sources may be similar to the power sources 112 more fully discussed with respect to FIG. 1.

As briefly discussed, the circuit portion 310 may comprise a controller (e.g., controller 114) of the wireless charging device 300 that facilitates transferring power from the power source to the coil 320, as further described herein. As illustrated, the circuit portion 310 includes a micro USB port 314 to allow communication between the circuit portion 310 and a power source (e.g., power source 112A of FIG. 1). Additionally, as shown, the circuit portion 310 includes an integrated circuit (IC) 312, as well as various components, including metal-oxide-semiconductor field-effect transistors (MOSFET's), resistors, and so forth. As such, the circuit portion 310 may include any combination of components (e.g., resistors, capacitors, and so forth) that are appropriate for a given IC 312 within the wireless charging device 300.

In some embodiments, the IC 312 may comprise an off-the-shelf IC such as an INTEGRATED DEVICE TECHNOLOGY® (IDT) chip. In other embodiments, the IC 312 may comprise a QI 555 Timer IC. The coil 320 may comprise a microstrip coil (thin coil strands). Microstrip has previously been used as a type of transmission line that can be generated on printed circuit boards (PCB's). Accordingly, the microstrip coil 320 (as well as the coil 920, the coil 1020A, and the coil 1020B) as further described herein, may each be printed as part of a PCB. As illustrated, each coil portion (i.e., starting from coil portion 322 to coil portion 324) of the coil 320 is spread out such that the coil strands/portions are close while not touching. In some embodiments, each coil strand/portion may be within a range of approximately 0.05 mm to 1 mm apart. For instance, each coil strand may be separated by approximately 0.1 mm. Additionally, open portion 326 (i.e., a middle portion of the coil that includes little-to-no coil strands) may also be fairly small, such that the largest spacing between coil strands of the microstrip coil 300 is within a range of 0.5 mm to 2 cm. In an example, the open portion 326 may be at least approximately 1 cm between coil strands/portions in any given direction.

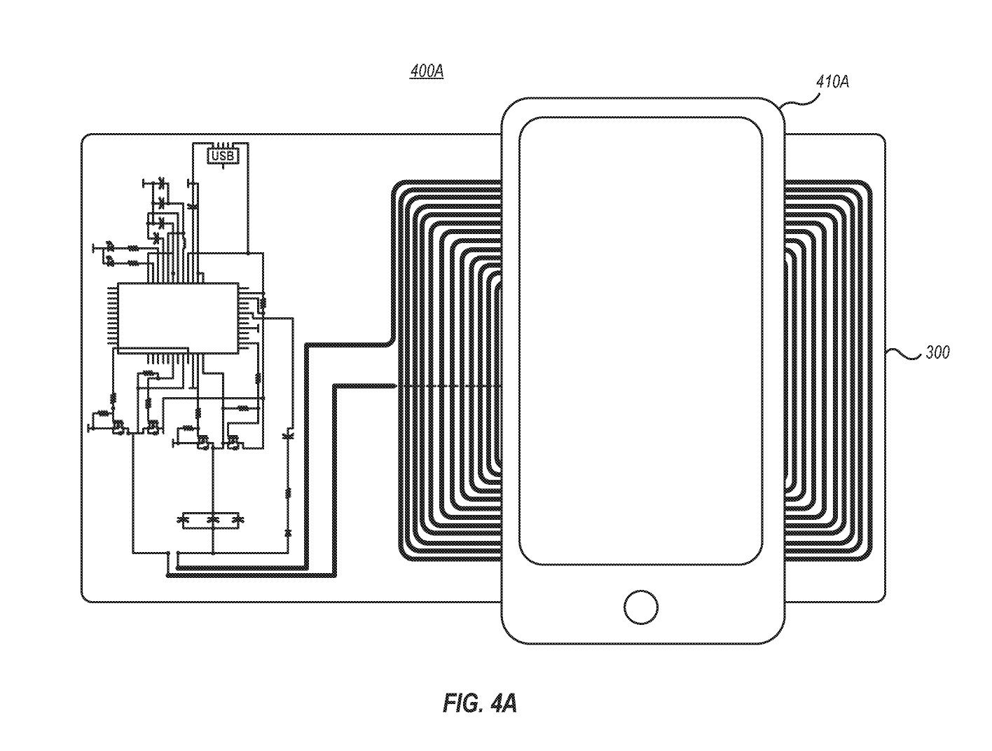

Notably, the combination of the layout of the circuit portion 310, the layout of the coil 320 (i.e., coil portions being close while not touching), and the utilization of microstrip as the coil 320, as illustrated in FIG. 3, may allow for placing an electronic device (i.e., a device to be charged) essentially anywhere (e.g., on a corner, in the middle, on a side, and so forth) on the wireless charging device 300 while still providing wireless charging to the electronic device. For instance, FIGS. 4A-4C illustrate different placement of a device 400 on top of wireless charging device 300. As shown, FIG. 4A illustrates electronic device 410A placed in the middle of wireless charging device 300, FIG. 4B illustrates electronic device 410B placed on a corner of wireless charging device 300, and FIG. 4C illustrates electronic device 410C placed on an edge/side of wireless charging device 300. Notably, practicing the principles described herein, each of the electronic device 410 (i.e., electronic device 410A through electronic device 410C) placements within FIGS. 4A-4C would allow for wirelessly charging the electronic device 410. In some embodiments, placing an electronic device on a single strand of coil (e.g., coil portion 324, coil portion 322, and so forth) of the wireless charging device 300 may be sufficient to charge the battery of the electronic device.

Additionally, the combination of the layout of the circuit portion 310, the layout of the coil 320 (i.e., coil portions being close s not touching), and the utilization of microstrip as the coil 320, as illustrated in FIG. 3, may also allow the microstrip coil 320 to collect power from a power supply (e.g., power source 112A and power source 112B of FIG. 1) and send the power directly up from the microstrip coil itself (and ultimately, to an electronic device to be charged that is placed on top of the wireless charging device 300). Accordingly, the need to attach a ferrite board (e.g., ferrite board 220 of FIG. 2) that provides a controlled environment for magnetic flux to the microstrip coil 320 is eliminated. Notably, utilizing microstrip for the coil 320, as well as the amount of copper (not shown) used within wireless charging device 300 aid in controlling the magnetic flux and sending power in a single direction (i.e., up to an electronic device that is placed on top of the wireless charging device 300). In some embodiments, the amount of copper used within the wireless charging device 300 may be within a range of approximately 0.5 oz to 8 oz. In an example, the amount of copper used within the wireless charging device may be 4 oz.

As briefly discussed, the wireless charging device 300 may comprise the board 330, at least a portion of which comprises a PCB. Without the use of a ferrite board in conjunction with a coil 320 that comprises microstrip, the board 330 can be very thin. For instance, in some embodiments, the thickness of board 330 (and ultimately, the entire wireless charging device 300) may be within a range of 0.2 mm to 0.4 mm. Notably, such thickness (e.g., 0.2 mm to 0.4 mm) may allow electronic devices (e.g., electronic device 120) to connect more quickly to the wireless charging device 300. For instance, an electronic device may connect to the wireless charging device 300 within a range of 0.36 seconds to 0.47 seconds. The thickness of the wireless charging device 300/board 320 in combination with a two-layered board 330 (and the microstrip coil 320) may also allow for a flexible design of the wireless charging device 300, as further described herein. Notably, such a flexible design may not be possible with standard coils and/or utilization of a ferrite board.

In some embodiments, the IC 312 may comprise a 15 Watts (W) chip (e.g., an IDT 15 W chip) that allows for charging an electronic device with a maximum output of 15 W from the wireless charging device 300. Notably, many electronic devices (e.g., smartphones) can only receive between 7.5 W and 10 W. As such, the wireless charging device 300 may generate another 5-7.5 W that can be used for an additional electronic device to be charged. Additionally, the wireless charging device 300, as described herein, may provide quick charging for electronic devices that are capable of quick charging under any applicable quick charge standard (e.g., QUICK CHARGE™, Apple Fast Charge, and so forth).

In an example, assume that a first electronic device that can receive up to 7.5 W of power for charging the device has been properly placed for charging on at least a portion of the wireless charging device 300. In such a scenario, a second electronic device that can also receive up to 7.5 W of power can also be placed on the wireless charging device 300, such that both the first and second electronic devices can each be charged by the wireless charging device at the same time (i.e., the wireless charging device is generating 15 W of power, 7.5 W being received by the first electronic device and the other 7.5 W being received by the second electronic device). Additionally, in some embodiments, the wireless charging device 300 may comprise a 5V charger. In other embodiments, the wireless charging device 300 may function at higher or lower voltages than 5V. For instance, if one or more of the power sources (e.g., power source 112A) deliver a higher voltage, the wireless charging device 300 can be rated for a higher voltage.

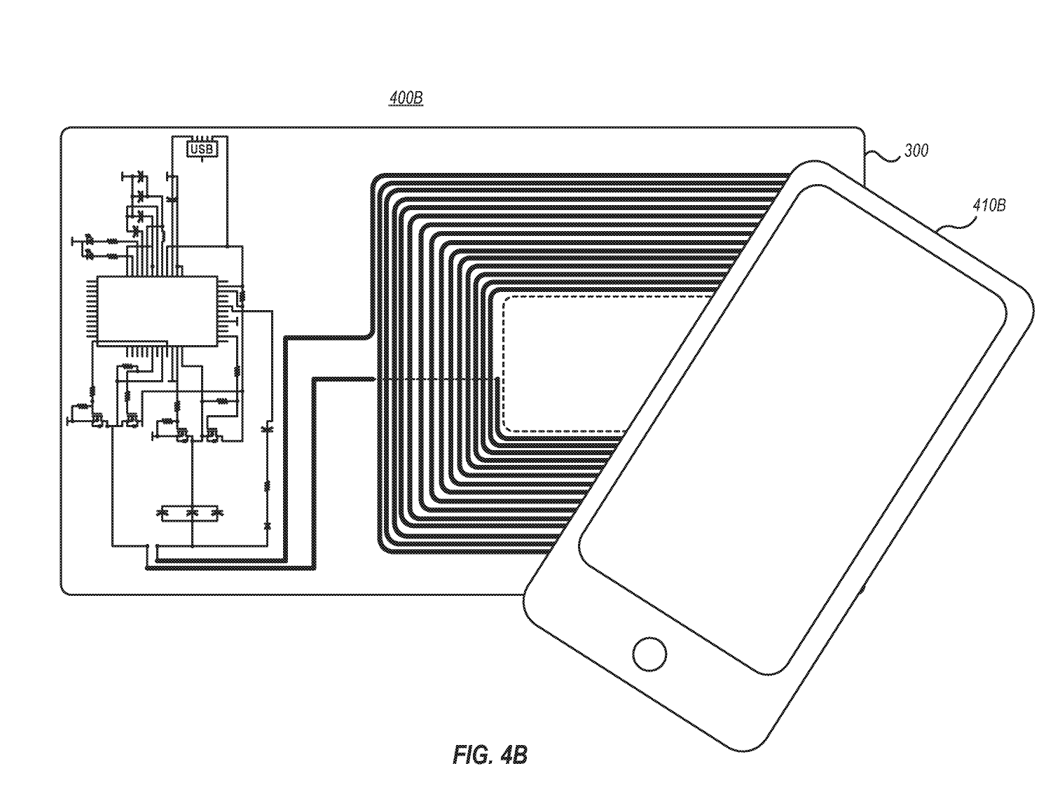

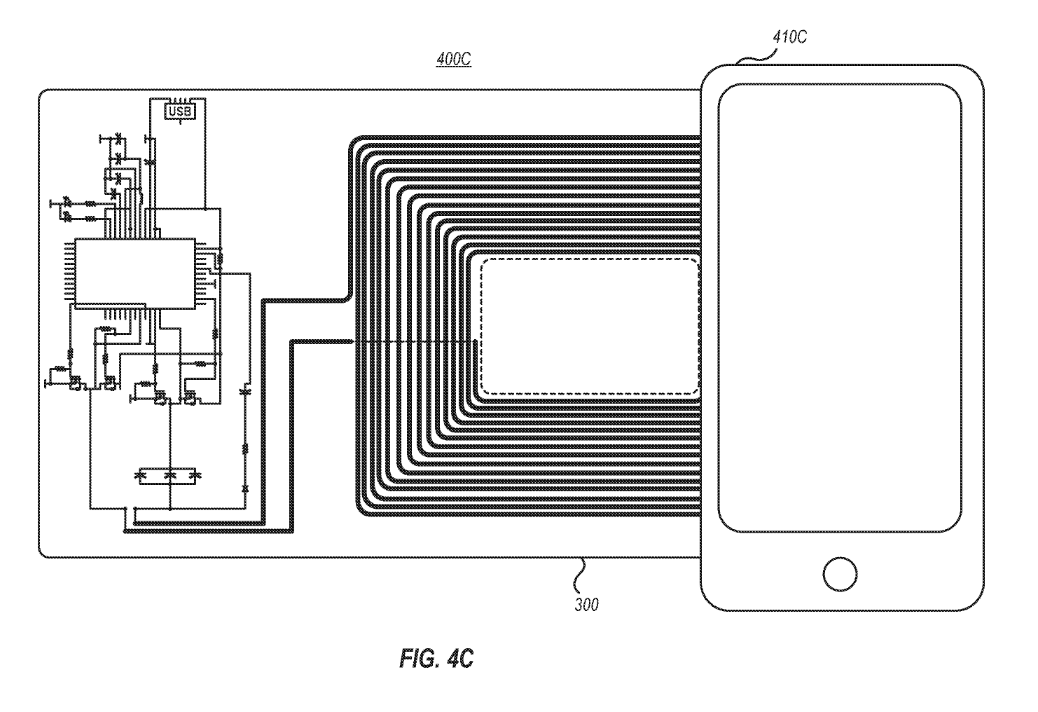

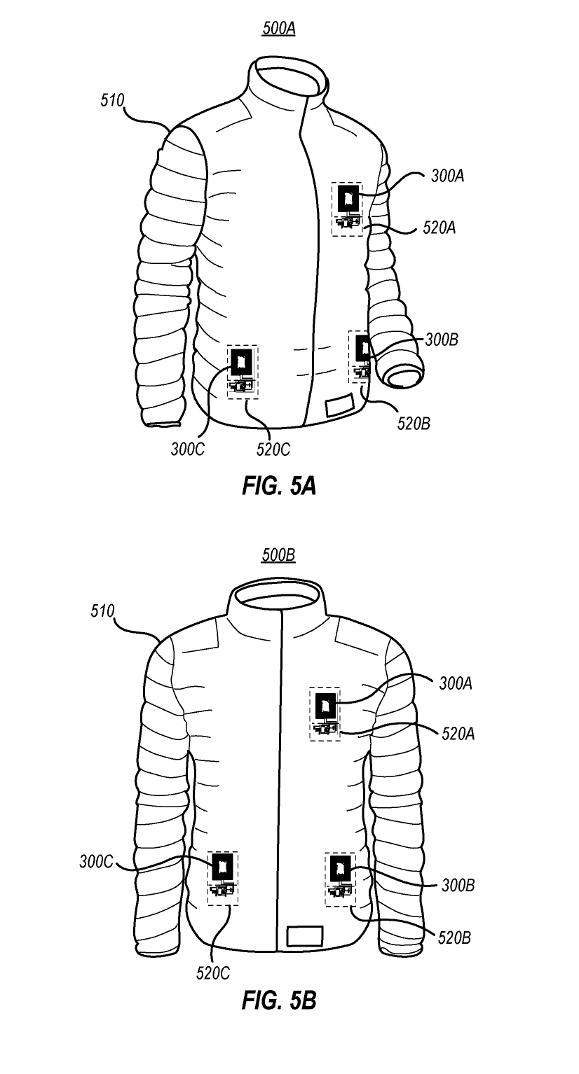

As shown in FIGS. 5A through 8, the wireless charging device 300, can be combined with a clothing item, garment, or product that is worn or carried by an individual. For instance, as illustrated in FIGS. 5A and 5B, one or more chargers 300 (i.e., wireless charger 300A through wireless charger 300C) can be included in an upper-body clothing item 510 (e.g., a coat, a jacket, a hoodie, a shirt, and so forth), and as illustrated in FIGS. 6 and 7, one or more chargers 300 can be included in a lower-body clothing item 610, 710 (e.g., shorts, pants, and so forth).

As illustrated in FIGS. 5A and 5B, the wireless charging device 300 can be included in various locations within a jacket/coat 510. Notably, while three wireless charging devices (i.e., wireless charging device 300A through wireless charging device 300C) are shown as being included within the jacket 510, any number of wireless charging devices 300 may be included within the jacket 510 (or another applicable clothing item). As illustrated, to aid with positioning each of the one more wireless charging devices 300, a container 520 (i.e., container 520A through container 520C) may be used for storing each of the wireless charging devices. In an example, the containers 520 may comprise a pouch, a pocket, and so forth. For instance, one of the containers 520 may comprise an inner surface of a lining of a pocket of the clothing item 510. In another example, one of the containers 520 may comprise an exterior surface of a lining of a pocket of the clothing item 510. In some embodiments, the wireless charging device 300 may be removeable from one or more of the containers 520. For instance, a user may remove the wireless charging device 300C from container 520C and utilize the wireless charging device 300C in another location (e.g., within a purse, a backpack, and so forth). In other embodiments, the wireless charging device may not be removable from one or more of the containers 520 (e.g., the wireless charging device is placed within a container 520 that is sewn shut).

Although not illustrated, an additional container corresponding to each container 520 may also be included for positioning one or more electronic devices (e.g., electronic device 120) for wirelessly charging the given one or more electronic devices via the stored wireless charging device 300. In a more specific example, the container 520A that includes wireless charging device 300A may include a corresponding container proximate to the container 520A (and the wireless charging device 300A) that can store an electronic device to be charged by the wireless charging device 300A. Notably, in embodiments that include a receiver (e.g., the receiver 122) that is a separate device from an electronic device (e.g., the electronic device 120) to be charged (i.e., as further described with respect to FIG. 1), the additional container may comprise an appropriate size and/or shape for storing both the electronic device to be charged and the separate receiver.

Alternatively, an electronic device to be charged may be placed within each container 520 (i.e., rather than being placed in a separate container proximate to the container 520), along with each wireless charging device 300, for wireless charging of the electronic device. Accordingly, each container 520 positions each wireless charging device 300 to inductively couple with an electronic device to be charged that is placed in or close to the given container 520, such as within a pocket of the clothing item 510. For instance, a pocket of the clothing item 510 can include a pouch sewn into or forming part of the lining of the pocket, such as a breast pocket, side pocket, or other pocket of the clothing item 510.

Notably, a particular location of each container 520, or the manner by which each wireless charging device 300 is stored or supported by a clothing item (e.g., clothing item 510, clothing item 610, and clothing item 710), can vary based upon a type of clothing or garment. For instance, a container 520 can be located on an exterior surface of the liner or fabric forming a pocket of the clothing such that the container 520 is positioned between a liner of a given clothing item and a user or between the liner and an inner liner of the clothing item. The container 520 can include one or more of the chargers 30. In another example, the one or more wireless charging devices 300 can be located in a container 520 on a waistband or other portion of a given clothing item that is inaccessible by a wearer of the clothing item, and that is, in some embodiments, distant from another container in which an electronic device to be charged can be received, while remaining within a sufficiently close distance to allow the one or more wireless charging devices to charge the electronic device. In yet another example, the wireless charging device 300 can be located in a portion of a belt or waistband, or other wearable technology or product, with an electronic device to be charged placed against, near, or adjacent to the belt or waistband, or other wearable technology or product through a support, such as a belt clip, holder, and so forth. In yet another example, a power source and/or wireless charging device may be coupled to a waistband of a clothing item.

While the above discussion generally references different portions of the clothing item 510, one skilled in the art could appreciate that the principles described herein can be practiced by utilizing wireless charging devices 300 that include controllers and power sources (as further described in FIG. 1) in either or both of an upper body clothing and a lower body clothing. The upper body clothing can include, for example and not by way of limitation to applicability of the present invention to other pieces of clothing worn on the upper body, jackets, sweaters, blazers, t-shirts, vests, blouses, tops, dresses, glovers, mittens, and more. Also, the lower body clothing can include, for example and not by way of limitation to applicability of the present invention to other pieces of clothing worn on the lower body, pants, trousers, shorts, skirts, etc. In addition, clothing items can include a garment that can be worn at least over a portion of the upper body and the lower body. Alternatively, or additionally, the principles described herein can be practiced by utilizing chargers, controllers, and power sources in products that are worn or carried by an individual, such as, but not limited to, backpacks, bags, briefcase, handbag, watches, bands, exercise trackers, and so forth.

While multiple wireless charging devices 300 are illustrated in clothing item 510, a single wireless charging device (having a controller and one or more power sources) could also be included. For instance, FIGS. 6 and 7 illustrate an embodiment in which only a single wireless charging device is included within a clothing item. For instance, FIG. 6 illustrates a lower body clothing item 610 (e.g., shorts) that includes a wireless charging device 300 stored within a container 620. In another example, FIG. 7 illustrates a lower body clothing item 710 (e.g., shorts) that includes a wireless charging device 300 stored within a container 720.

Additionally, while not shown, a controller (e.g., the controller 114) associated with the wireless charger 300 may be hidden within a waistband of a clothing item (e.g., the clothing time 510, the clothing item 610, the clothing item 710, and so forth). Alternatively, such a controller can be integrated into the wireless charging device 300 (i.e., the wireless charging device 300 includes control circuitry, such as an IC, that controls the output of the wireless charging device 300 and forms a bridge between the wireless charging device and any associated power sources, as illustrated by circuit portion 310 of FIG. 3).

Although not shown cables and/or wires may extend from each of the one or more wireless charging devices 300 to one or more corresponding power sources (e.g., power source 112A and power source 112B) to provide electrical communication therebetween. In some embodiments, such wires/cables are integrated into a waistband of a clothing item (e.g., clothing item 610) to act as a bridge between all devices. For instance, such cables/wires may comprise a standard micro USB cable that communicates power from a port of the wireless charging device 300 to a port of a power source. While Micro USB cables and ports are used as an example herein, any appropriate type or standard of cables and/or ports may be used to practice the principles described herein.

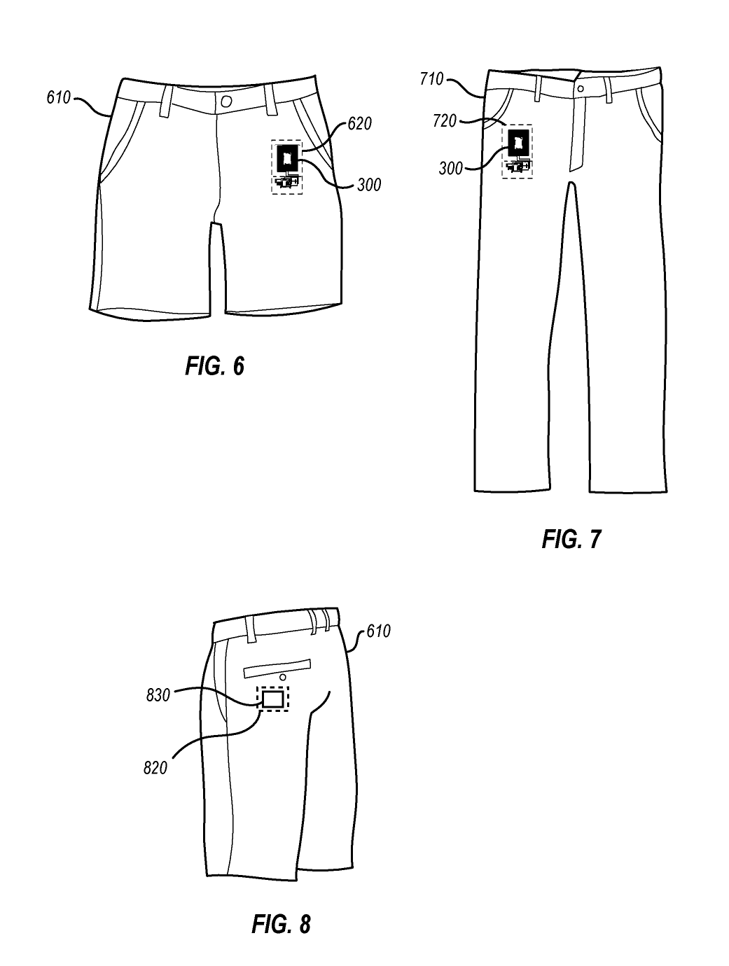

FIG. 8 illustrates an example of potential placement of a power source 830 within the clothing item 610 of FIG. 6. As illustrated, the power source 830 is included within a container 820 (e.g., a pocket, a pouch, and so forth) of the clothing item 610. While the power source 830 is illustrated as being within or proximate a back pocket of the clothing item 610, the power source 830 may be placed essentially anywhere within the clothing item 610. In an example, the power source 830 may include one or more slim portable batteries. While each of the wireless chargers 300 within an item of clothing may be enclosed (i.e., such that a user cannot access any given wireless charger), the power source 830 may be accessible to a user such that the power source 830 can be removed, recharged, and returned to the clothing item. For instance, a user can remove the power source 830, connect the power source 830 to a power outlet via a port of the power source (e.g., an AC adapter utilizing a USB port corresponding to the power source). Upon charging the power source 830, the power source may once again be placed within the clothing item. In some embodiments, the power source 830 can include indicia representing a level of power remaining within the power source. For instance, the power source 830 can include lights representing a charging level.

Returning to FIG. 3, the board 330 of the wireless charging device 330 may be a one-layered board. In other embodiments, the board 330 may comprise a board with two or more layers. In an example, the coil 320 may be printed onto the board 330 during manufacture. Notably, two-layered (or more) boards may provide more durability, while one-layered boards may provide more flexibility. Accordingly, the flexibility of a one-layered board may allow for seamlessly placing the wireless charging device 300 within shorts, t shirts, jackets, sweaters, gloves, and other tight-fitting clothing. Similarly, the durability of a two-layered (or more) board may allow for seamlessly placing the wireless charging device 300 within backpacks, jackets, hoodies, snow pants, and other similar clothing items that would likely require more durability from a wireless charger.

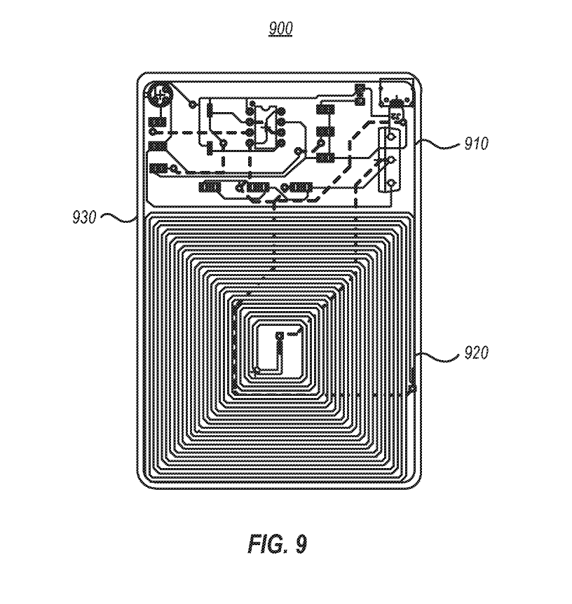

FIG. 9 illustrates a wireless charging device 900 that includes many of the features of the wireless charging device 300, including use of microstrip coils, a thin and flexible board, an ability to charge a device that is placed essentially anywhere proximate to the coil portion of the wireless charging device 900 (i.e., as further described with respect to FIGS. 3 through 4C) and so forth. Notably, the wireless charging device 900 includes a circuit portion 910 that utilizes a QI 555 Timer IC and corresponding components appropriate for the QI 555 Timer IC. As shown, and briefly described, the wireless charging device 900 also includes a microstrip coil portion 920, and a thin, flexible board 930.

Notably, the wireless charging device 900 (as well as the charging device 300) may be charged using a fast charging standard, as further described herein. Additionally, the wireless charging device 900 may generate a square wave having a frequency range of medium power Qi chargers (i.e., 80-300 kHz). In some embodiments, a high-power N-channel MOSFET may be utilized with respect to the output of QI 555 Timer IC in order provide currents that are not attainable when only using the QI 555 Timer IC. Furthermore, the wireless charging device 900 (and the wireless charging device 300) may comply with high power QI standards.

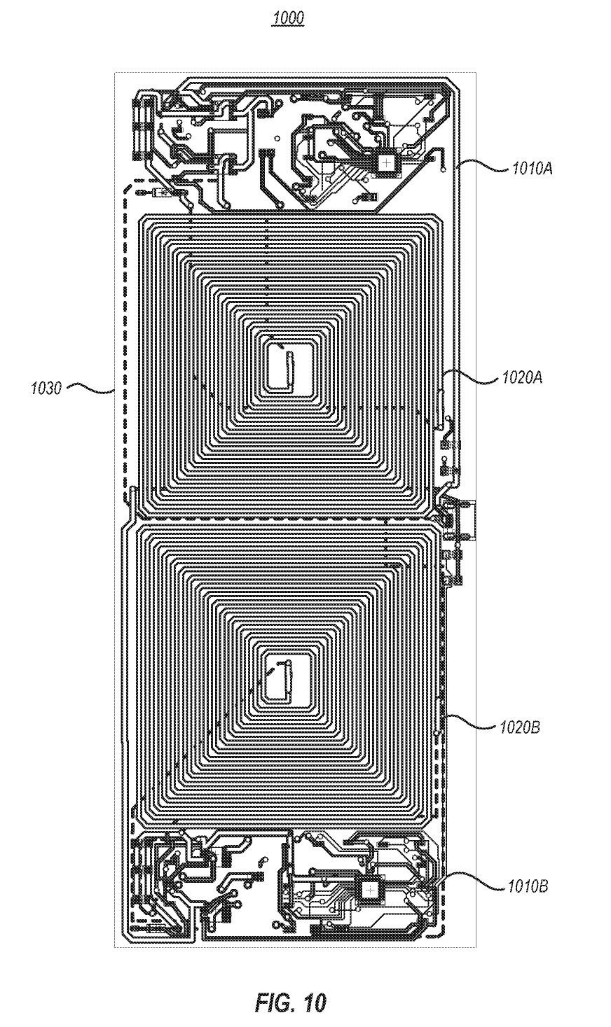

FIG. 10 illustrates a wireless charging device 1000 that includes two circuit portions 1010 (i.e., circuit portion 1010A and circuit portion 1010B), two coil portions 1020 (i.e., coil portion 1020A and coil portion 1020B), and a board portion 1030. In some embodiments, the wireless charging device may utilize an IDT IC. The wireless charging device 1000 may also include the features described herein with respect to the wireless charging device 300 and the wireless charging device 900, including use of microstrip coils, a thin and flexible board, an ability to charge a device that is placed essentially anywhere proximate to the coil portion of the wireless charging device 1000 (i.e., as further described with respect to FIGS. 3 through 4C) and so forth. In addition, while FIGS. 4A through 8 are discussed as utilizing the wireless charging device 300, the wireless charging device 900 and the wireless charging device 1000 may each be similarly utilized. Notably, the two coil portions 1020 of the wireless charging device 1000 may allow for placement (and charging) of three or more devices to be charged on the wireless charging device 1000, at the same time.

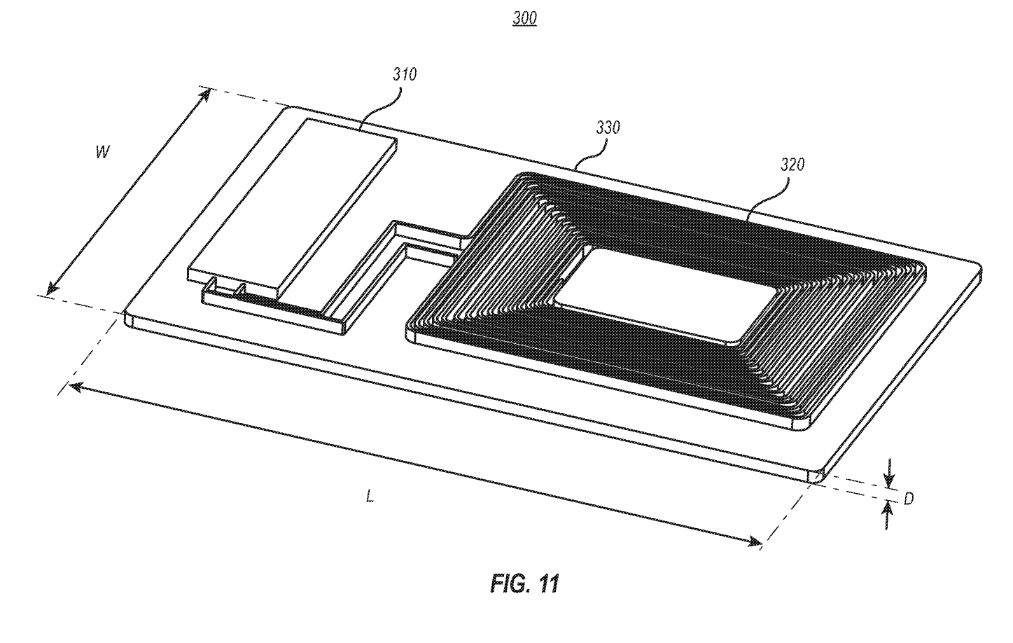

FIG. 11 illustrates a wireless charging device 300 (or the wireless charging device 900) having a width a, a length, and a thickness. Notably, the board 330, the board 930, the board 1030, and more generally the wireless charging devices themselves (i.e., the wireless charging device 300, the wireless charging device 900, and the wireless charging device 1000), can comprise various widths, lengths, and thicknesses based upon a particular intended use. In an example, the wireless charging device has a length of about 66 mm, a width of about 44 mm, and a height of about 0.2 mm. In another configuration, the PCB or charger has a length of about 99 mm, a width of about 77 mm, and a thickness (or depth) of about 1 mm. In other configurations, the length can range from about 50 mm to about 150 mm, the width can range from about 30 mm to about 100 mm, and the thickness can range from about 0.003 mm to about 3 mm. In other configurations, the wireless charging device 300 can be about 75 mm (about 2.95 inches) in width, about 104 mm (about 4.1 inches) in length, and a thickness of about 0.003 mm (about 0.00013 inches), such as for use in larger items. In still another configuration, the wireless charging device can be about 63.5 mm (about 2.5 inches) in width, about 91.4 mm (about 3.6 inches) in length, and about 0.003 mm (about 0.00013 inches) in thickness, such as for smaller items. In yet another configuration, the wireless charging device can be about 68.6 mm (about 2.70 inches) in width, about 100.6 mm (about 3.96 inches) in length, and about 0.003 mm (about 0.00013 inches) in thickness. In still another configuration, the wireless charging device can be about 87.12 mm (about 3.43 inches) in width, about 211.58 mm (about 8.33 inches) in length, and about 0.003 mm (about 0.00013 inches) in thickness. In yet another configuration, the wireless charging device can be about 87.12 mm (about 3.43 inches) in width, about 211.58 mm (about 8.33 inches) in length, and about 1.524 mm (about 0.06 inches) in thickness.

In this way, a wireless charging device may be extremely thin, flexible, and light. Such properties (i.e., thickness, flexibility, and weight) may allow the wireless charging device to be integrated within an item of clothing of an individual, as the wireless charging device is configured to flex and bend in response to movements of the individual that is wearing the item of clothing. Notably, these properties are realized based at least partially on the usage of a microstrip coil that does not include strands of coil that touch between different layers of coil. For instance, the microstrip coil, as described herein, allows for controlling magnetic flux of the coil and generating power in a particular direction without the use of a ferrite board. Additionally, these features allow for charging an electronic device to be wireless charged even when placing the electronic device on a single strand of the microstrip coil.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A wireless charging device, comprising:
a controller that is configured to be coupled to one or more power sources, the controller further being configured to facilitate transferring power from one or more power sources to a microstrip coil;
the microstrip coil coupled to the controller, the microstrip coil being configured to receive power from the one or more power sources via the controller and create an electromagnetic field for transmitting power to an electronic device; and
a board coupled to the controller and the microstrip coil.

2. The wireless charging device of claim 1, wherein the wireless charging device is configured to provide power in a particular direction without a ferrite board.

3. The wireless charging device of claim 2, the wireless charging device is integrated within a clothing item that includes at least one pocket, wherein at least a portion of the wireless charging device is located within the at least one pocket.

4. The wireless charging device of claim 3, wherein a cable within the clothing item extends between the power source and the charger.

5. The wireless charging device of claim 4, wherein the cable is a micro universal serial bus cable.

6. The wireless charging device of claim 3, wherein the wireless charging device is located with an inner surface of a lining of the pocket.

7. The wireless charging device of claim 3, wherein the wireless charging device is located with an exterior surface of a lining of the pocket.

8. The wireless charging device of claim 3, wherein the power source is coupled to a waistband of the clothing item.

9. A wireless charging device, comprising:
a controller that is configured to be coupled to one or more power sources, the controller further being configured to facilitate transferring power from one or more power sources to a coil;
the coil coupled to the controller, the microstrip coil being configured to receive power from the one or more power sources via the controller and create an electromagnetic field for transmitting power to an electronic device; and
a board coupled to the controller and the coil, wherein the wireless charging device is configured to provide power to the electronic device in a particular direction without a ferrite board.

10. The wireless charging device of claim 9, wherein the coil comprises a microstrip coil.

11. The wireless charging device of claim 10, the wireless charging device is integrated within a clothing item that includes at least one pocket, wherein at least a portion of the wireless charging device is located within the at least one pocket.

12. The wireless charging device of claim 11, wherein a cable within the clothing item extends between the power source and the charger.

13. The wireless charging device of claim 12, wherein the cable is a micro universal serial bus cable.

14. The wireless charging device of claim 11, wherein the wireless charging device is located with an inner surface of a lining of the pocket.

15. The wireless charging device of claim 11, wherein the wireless charging device is located with an exterior surface of a lining of the pocket.

16. The wireless charging device of claim 11, wherein the power source is coupled to a waistband of the clothing item.

17. A wireless charging system, comprising:
a wireless charging device, wherein the wireless charging device includes:
a controller that is configured to be coupled to one or more power sources, the controller further being configured to facilitate transferring power from the one or more power sources to a microstrip coil;
the microstrip coil coupled to the controller, the microstrip coil being configured to receive power from the one or more power sources via the controller and create an electromagnetic field for transmitting power to an electronic device; and
a board coupled to the controller and the microstrip coil, wherein the wireless charging device is configured to provide power to the electronic device in a particular direction without a ferrite board; and
the electronic device, wherein the electronic device includes:
a receiver that is coupled to a battery, wherein the receiver is configured to receive power transmitted by the wireless charging device and provide the received power to the battery; and
the battery, wherein the battery is configured to be charged by the power received at the receiver.

18. The wireless charging system of claim 17, the wireless charging device is integrated within a clothing item that includes at least one pocket, wherein at least a portion of the wireless charging device is located within the at least one pocket.

19. The wireless charging system of claim 18, wherein a cable within the clothing item extends between the power source and the charger.

20. The wireless charging system of claim 18, wherein the wireless charging device is located with an inner surface of a lining of the at least one pocket.
